(19) United States
(12) Patent Application Publication
(10) Pub. No.: US 2021/0022546 A1
(43) Pub. Date: Jan. 28, 2021

(54) HEAT EXCHANGER FOR DISCHARGE CONTAINERS OF SOLENOID VALVES OF MACHINES FOR COFFEE DISPENSING, RELATIVE DISCHARGE CONTAINER EQUIPPED WITH SUCH HEAT EXCHANGER AND MACHINE FOR COFFEE DISPENSING PROVIDED WITH SUCH DISCHARGE CONTAINER AND SUCH HEAT EXCHANGER

(71) Applicant: SIMONELLI GROUP S.P.A., Belforte Del Chienti (IT)

(72) Inventors: Claudio CINGOLANI, Camerino (IT); Mario Rinaldesi, Corridonia (IT); Luca Cognigni, Macerata (IT)

(73) Assignee: SIMONELLI GROUP S.P.A., Belforte Del Chienti (IT)

(21) Appl. No.: 16/935,337

(22) Filed: Jul. 22, 2020

(30) Foreign Application Priority Data
Jul. 25, 2019 (IT) 102019000012945

(51) Int. Cl. A47J 31/46; A47J 31/44; A47J 31/54

(52) U.S. Cl. CPC A47J 31/461; A47J 31/007; A47J 31/54; A47J 31/4403

(57) ABSTRACT

A heat exchanger includes a body placed inside a discharge container of a solenoid valve of a machine for coffee dispensing. The body includes: a first portion presenting a collection cavity of a hot waste fluid coming from the solenoid valve of the machine and defining a first surface arranged to come into contact with the hot waste fluid and a second surface facing the opposite side from the first surface; and a second portion presenting a primary surface in contact with the second surface of the first portion and a secondary surface opposed to the primary surface, arranged to come into contact with a heat exchange fluid of the machine having a different temperature from the temperature of the hot waste fluid. The first and second portions allow heat exchange, by conduction, between the hot waste fluid and the heat exchange fluid of the machine.

The present invention relates to a heat exchanger, in particular with indirect contact, preferably on the surface, for discharge containers of solenoid valves of machines for coffee dispensing, in accordance with the present invention.

The object of the present invention also relates to a discharge container for solenoid valves of machines for coffee dispensing equipped with the aforesaid heat exchanger.

The object of the present invention is also a machine for coffee dispensing equipped with a discharge container for solenoid valves of machines for coffee dispensing provided with the aforesaid heat exchanger.

The object of the present invention refers to the technical industrial sector of machines for coffee dispensing in general and, in particular, it is aimed at professional machines for coffee dispensing.

As is known, the technical sector of machines for coffee dispensing is becoming more and more aligned with the general needs of reducing energy consumption and increasing the general performance of the machines that are produced and marketed.

The growing efforts by the manufacturers of machines for coffee dispensing has gradually allowed to obtain a greater reduction of heat losses to the outside, optimize the powers and spaces of the internal components of the same, as well as achieve significant results in terms of energy saving and overall dimensions.

Despite the various efforts to limit waste of heat to the maximum, the Applicant has found that there are still significant margins for improvement especially in relation to the discharges of the solenoid valves that manage the hot water flows destined for the extraction of coffee.

With particular reference to the extraction of coffee in current machines for the preparation and for dispensing the relative hot beverage, said operation is carried out by controlling corresponding flows of water heated to 90° C. which pass through respective three-way solenoid valves arranged at respective dispensing groups.

The actuation of each solenoid valve causes the transit of hot water through the corresponding dispensing group and the relative extraction of the coffee.

Once the coffee has been extracted, the excess hot water that is between the coffee panel and the shower head of the dispensing group is expelled into the discharge in order to lower the pressure in the area of the filter holder and thus allow the operator to remove the filter holder quickly and easily.

The hot water that is discharged by each solenoid valve first flows directly into a respective discharge container and, subsequently, into the discharge of the machine for coffee dispensing resulting in a significant waste of heated water potentially reusable for the purpose of the recovery of thermal energy.

The main object of the present invention is to propose a heat exchanger, in particular with indirect contact, preferably on the surface, for discharge containers of solenoid valves of machines for coffee dispensing, a relative discharge container equipped with such heat exchanger and a machine for coffee dispensing equipped with such discharge container and the relative heat exchanger, capable of solving the problems encountered in the prior art.

It is also an object of the present invention to further reduce the heat losses of the machines for coffee dispensing.

It is also an object of the present invention to increase the performance of the machines for coffee dispensing.

A further object of the present invention is to optimize the powers of the internal components of the machines for coffee dispensing.

Finally, an object of the present invention is to reduce the overall energy consumption of the machines for coffee dispensing required to heat the supply water coming from the water network or from a similar supply source.

The purposes specified above and others are substantially achieved by a heat exchanger, in particular with indirect contact, preferably on the surface, for discharge containers of solenoid valves of machines for coffee dispensing, a relative discharge container provided with such heat exchanger and a machine for coffee dispensing provided with such discharge container and the relative heat exchanger, as described and claimed below.

By way of example, the description of a preferred but not exclusive embodiment of a heat exchanger, in particular with indirect contact, preferably on the surface, for discharge containers of solenoid valves of machines for coffee dispensing, a relative discharge container provided with such heat exchanger and a machine for coffee dispensing provided with such discharge container and the relative heat exchanger, is reported in accordance with the present invention.

Such description will be made herein below with reference to the accompanying drawings, provided for indicative only and therefore not limiting purpose, in which:

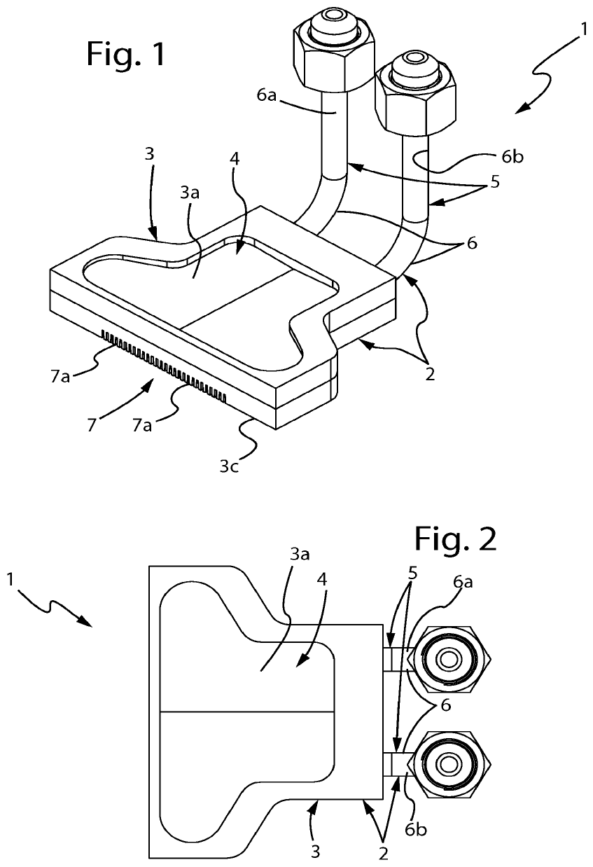

FIG. 1 is a perspective view from above of a heat exchanger, in particular with indirect contact, preferably on the surface, for discharge containers of solenoid valves of machines for coffee dispensing, in accordance with the present invention;

FIG. 2 is a top view of the heat exchanger of FIG. 1;

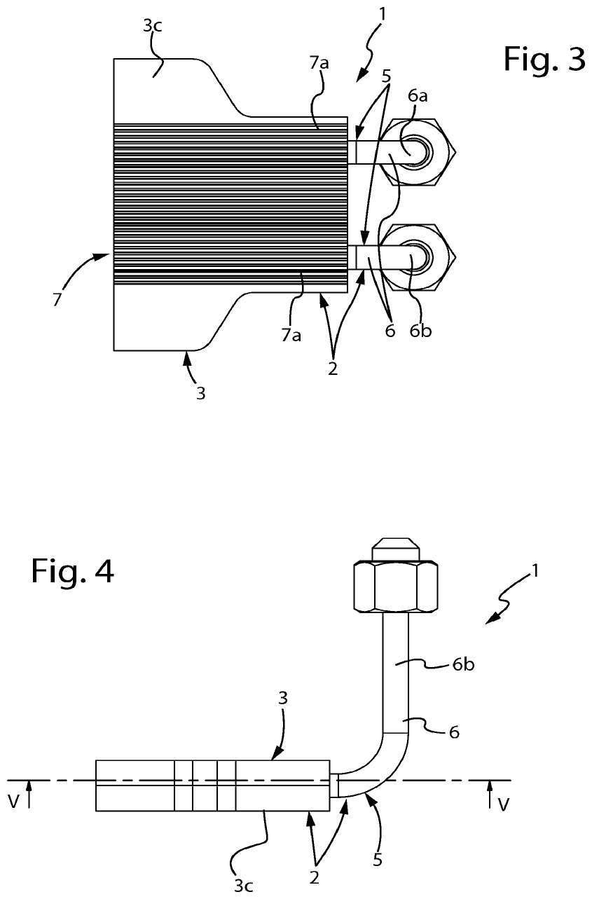

FIG. 3 is a bottom view of the heat exchanger as per FIGS. 1 and 2;

FIG. 4 is a side elevation view of the heat exchanger as per FIGS. 1 to 3;

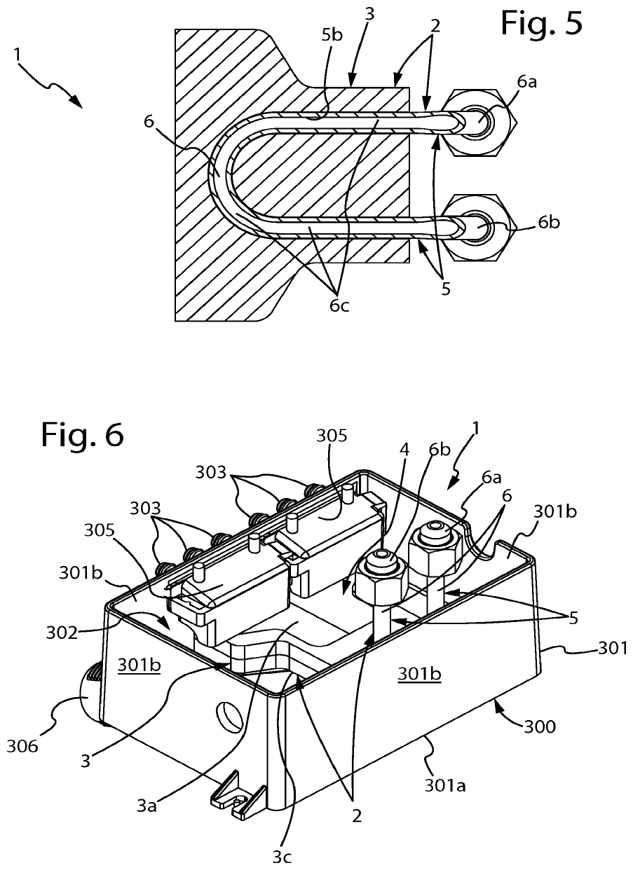

FIG. 5 is a section of the heat exchanger as per figures from 1 to 4, taken along the trace V-V of FIG. 4;

FIG. 6 is a perspective view from above of a discharge container for solenoid valves of machines for coffee dispensing equipped with the aforesaid heat exchanger, in accordance with the present invention;

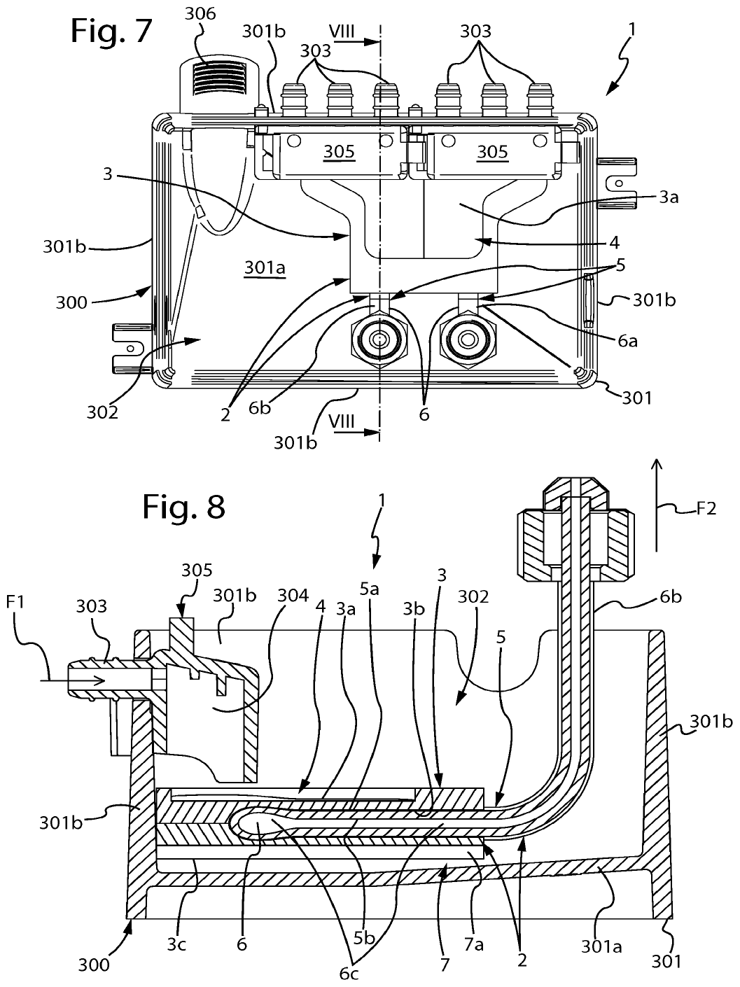

FIG. 7 is a top view of the discharge container of FIG. 6;

FIG. 8 is a section of the discharge container as per FIGS. 6 and 7, taken according to the trace VIII-VIII of FIG. 7;

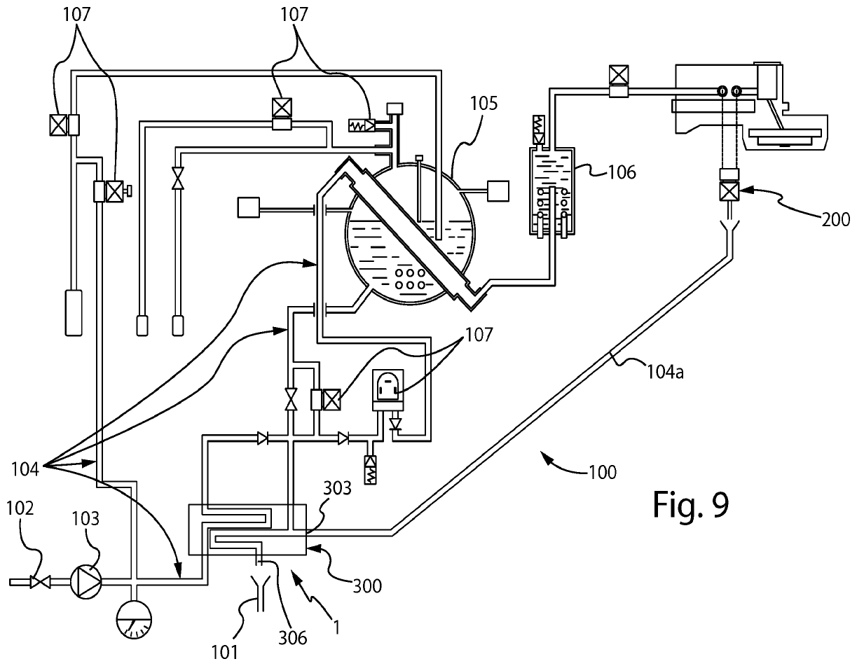

FIG. 9 is a hydraulic diagram of a machines for coffee dispensing provided with the discharge container as per FIGS. 6 to 8 and with the heat exchanger as per FIGS. 1 to 8, in accordance with the present invention.

With reference to the accompanying figures, the number 1 indicates overall a heat exchanger, in particular with indirect contact, preferably on the surface, for discharge containers 300 of solenoid valves 200 of machines 100 for dispensing coffee.

As can be seen in FIGS. 1 to 8, the heat exchanger 1 comprises a body 2 which can be placed inside a discharge container 300 of at least one solenoid valve 200 of a machine 100 for coffee dispensing (schematically represented in FIG. 9).

The body 2 comprises a first portion 3 externally presenting a collection cavity 4 of a hot waste fluid F1 coming from at least one solenoid valve 200 of the machine 100 for coffee dispensing.

In detail, the collection cavity 4 defines a first surface 3a of the first portion 3, arranged to come into contact with the hot waste fluid F1 (FIG. 8) coming from at least one solenoid valve 200 of the machine 100 for coffee dispensing and a second surface 3b (FIG. 8) arranged on the opposite side of the first surface 3a.

The heat exchanger 1 further comprises a second portion (FIGS. 1 to 8) presenting a primary surface 5a (FIG. 8) in contact, preferably direct, with the second surface 3b of the first portion 3 of the body 2 and a secondary surface 5b (FIGS. 5 and 8) facing the opposite side from the first surface 5a.

The secondary surface 5b of the second portion 5 of the body 2 is arranged to come into contact with a heat exchange fluid F2 of the machine 100 for coffee dispensing having a temperature different from the temperature of the hot discharge fluid F1 of the solenoid valve 200.

By means of the surfaces 3a, 3b, 5a, 5b respectively of the first portion 3 and of the second portion 5 of the body 2 of the heat exchanger 1, the first and the second portion 3, 5 of the body 2 allow and ensure an exchange of heat, by conduction, between the hot discharge fluid F1, coming from at least one solenoid valve 200 of the machine 100, in contact with the first surface 3a of the first portion 3 of the body 2 and the heat exchange fluid F2 of the machine 100 in contact with the secondary surface 5b of the second portion 5 of the body 2.

Going more and more into detail, as can be seen in FIGS. 1 to 8, the second portion 5 of the body 2 of the heat exchanger 1 comprises a transit duct 6 of the heat exchange fluid F2 of the machine 100 for coffee dispensing.

The transit conduit 6 has at least one supply fitting 6a of the heat exchange fluid F2 coming from the machine 100 for coffee dispensing which develops outside the first portion 5 of the body 2 of the heat exchanger 1.

Advantageously, the supply fitting 6a of the transit conduit 6 can be connected to a water supply duct coming from the water network or from a similar source of water supply.

The transit conduit 6 also has at least one outlet fitting 6b of the heat exchange fluid F2 which must reach the machine 100 for coffee dispensing. Similarly to the supply fitting 6a of the duct 6, the outlet fitting 6b also develops outside the first portion 5 of the body 2 of the heat exchanger 1, preferably substantially parallel to the supply fitting 6a.

The supply fitting 6a and the outlet fitting 6b of the transit duct 6 of the heat exchange fluid F2 of the machine 100 for coffee dispensing each develops transversely, preferably perpendicularly, to a prevailing development plane of the first portion 5 of the body 2 of the heat exchanger 1.

With reference to FIGS. 5 and 8, the transit duct 6 also has at least one transit segment 6c developing inside the first portion 5 of the body 2 of the heat exchanger 1, preferably in correspondence of the first surface 3a of the latter. The transit segment 6c of the transit duct 6 is in fluid communication with the supply fitting 6a and outlet fitting 6b of the heat exchange fluid F2 of the machine 100 for coffee dispensing.

As can be seen in FIG. 5, the transit segment 6c of the transit duct 6 defining the second portion 5 of the body 2 of the heat exchanger 1 develops inside the first portion 5 of the body 2 of the latter according to a substantially C-shaped path.

With reference to FIG. 8, the primary surface 5a of the second portion 5 of the body 2 of the heat exchanger 1 is defined by the outer surface of the transit duct 6 of the heat exchange fluid F2 at least in correspondence of the transit segment 6c of the latter.

The secondary surface 5b of the second portion 5 of the body 2 of the heat exchanger 1 is defined by the internal surface of the transit duct 6 of the heat exchange fluid F2 at least in correspondence of the transit segment 6c.

Still with reference to FIGS. 5 and 8, the second surface 3b of the first portion 3 of the body 2 of the heat exchanger 1 is defined by the surface of the first portion 5 in direct contact with the outer surface of the transit duct 6 of the heat exchange fluid F2 of the machine 100 for coffee dispensing at least in correspondence of the transit segment 6c.

Advantageously, the second surface 3b of the first portion 3 of the body 2 of the heat exchanger 1 is at least in part, preferably completely, counter-shaped to the primary surface 5a of the second portion 5, i.e. to the outer surface of the transit segment 6c of the transit duct 6.

As can be seen in FIGS. 1, 3 and 8, the first portion of the body 2 of the heat exchanger 1 present at least one auxiliary heat exchange area 7 provided with a plurality of fins 7a which favour the heat exchange between the first portion 3 itself and the fluid present inside the discharge container 300 of the solenoid valve 200 of the machine 100 for coffee dispensing.

Still with reference to FIGS. 1, 3 and 8, the auxiliary exchange area 7 is arranged on a third surface 3c of the first portion 3 of the body 2 of the heat exchanger 1 facing the opposite side with respect to the first surface 3a and outwards.

As can be seen in FIG. 8, the second portion 5 of the body 2 of the heat exchanger 1 and the second surface 3b of the first portion 3 of the same body 2 are interposed between the first surface 3a and the third surface 3c of the latter.

In order to allow an easy and smooth insertion of the heat exchanger 1 into the discharge container 300 of the solenoid valve 200 of the machine 100 for coffee dispensing, the first portion 3 of the body 2 of the heat exchanger 1 presents a substantially flattened external and/or overall conformation (FIGS. 1, 4, 6 and 8).

The first portion 3 of the body 2 of the heat exchanger 1 also presents a substantially trapezoidal shape.

Preferably, the shape of the first portion 3 of the body 2 of the heat exchanger 1 narrows as it approaches the supply 6a and outlet 6b fittings of the transit duct 6.

Furthermore, the subject matter of the present invention is also a discharge container 300 (FIGS. 6 to 9) for at least one solenoid valve 200 of a machine 100 for coffee dispensing.

As can be seen in FIGS. 6 to 8, the discharge container 300 comprises a structure 301 having a substantially rectangular bottom 301a, from which four side walls 301b develop substantially perpendicularly, opposed two by two.

The bottom 301a and the side walls 301b together define a housing compartment 302 for collecting a hot waste fluid F1 coming from at least one solenoid valve 200 of the machine 100 for coffee dispensing.

Still with reference to FIGS. 6 to 8, the discharge container 300 is provided with at least one inlet 303 for the transit of the relative hot waste fluid F1 coming from at least one respective solenoid valve 200 of the machine 100 for coffee dispensing.

In accordance with the embodiment illustrated in FIGS. 6 to 8, the discharge container 300 is provided with a series of inlets 303 which convey, for example in groups of three, the hot waste fluid F1 at the inlet into the respective deflection chambers 304 made of corresponding inlet blocks 305 which engage at least one of the side walls 301b of the structure 301 of the discharge container 300.

As can be seen in FIG. 8, each deflection chamber 304 is configured in such a way as to convey the flow of the hot waste fluid F1 coming from at least one solenoid valve 200 of the machine 100 for coffee dispensing towards the bottom 301a of the structure 301 of the discharge container 300.

The discharge container 300 also includes at least one outflow outlet 306 to allow the outflow of the hot waste fluid F1 accumulated inside the housing compartment 302 towards the final discharge 101 of the machine 100.

As can be seen in FIGS. 6 and 8, the heat exchanger 1 is positioned inside the housing compartment 302 of the discharge container 300 so as to present the collection cavity 4 of the hot waste fluid F1 coming from the respective solenoid valves 200 of the machine 100 for coffee dispensing and, consequently, the first surface 3a of the first portion 3 of the relative body 2 arranged below the inlets 303 of said waste fluid F1.

In other words, the body 2 of the heat exchanger 1 is interposed between the inlets 303 of the hot waste fluid F1 coming from the solenoid valves 200 of the machine 100 for coffee dispensing and the outflow outlet 306 of the discharge container 300.

In this way, at the end of each coffee extraction operation, the excess hot waste fluid F1 is sent to the discharge container 300 entering the housing compartment 302 of the latter through the respective inlet 303 and the corresponding deflection chamber 304.

Each deflection chamber 304 directs the respective flow of fluid F1 at the inlet towards the collection cavity 4 of the heat exchanger 1 by heating the first portion 3 of the latter and, consequently, the transit segment 6c of the duct 6 of the second portion 5. The passage of the heat exchange fluid F2 along the transit segment 6c of the transit duct 6, which is indirectly heated by the hot waste fluid F1 through the first portion 3 of the body 2 of the heat exchanger 1, consequently heats the heat exchange fluid F2 which is sent to the machine 100 through the outlet fitting 6b in order to be reused by it.

As can be seen in the schematic representation of FIG. 9, the machine 100 for coffee dispensing is a machine of a known type which comprises:
a general supply valve 102 connectable to a water network or a similar water supply source arranged in series with a feed pump 103;
a hydraulic circuit 104 developing from the general supply valve 102 affecting all the components of the machine 100 for dispensing coffee;
at least one indirect heating boiler 105 of the water and at least one direct heating boiler 106 of the water operatively arranged between the general valve 102 and the solenoid valves 200 destined for coffee dispensing to heat the water supply up to the temperature suitable for the coffee extraction;
a series of valves and/or components 107 necessary for the correct operation of the machine 100 for coffee dispensing.

Advantageously, as can be seen in the diagram of FIG. 9, the discharge container 300, provided with the aforesaid heat exchanger 1, is in fluid communication with at least one of the solenoid valves 200 of the machine 100 through a respective collection duct 104a of the hydraulic circuit 104. The excess water at the end of the extraction of the coffee corresponding to the hot waste fluid F1 is conveyed through the collection duct 104a towards the respective inlet 303 of the discharge container 300 so as to flood the body 2 of the heat exchanger 1 arranged in it, consequently heating both the first portion 3 and the transit duct 6 of the second portion 5.

Still with reference to FIG. 9, the supply water coming from the general supply valve 102, corresponding to the heat exchange fluid F2, is conveyed directly to the supply fitting 6a of the transit duct 6 of the second portion 5 of the body 2 of the heat exchanger 1 so as to travel through the transit segment 6c and be heated by the effect of the heat exchange between the waste fluid F1 and the portions 3, 5 of the body 2 of the heat exchanger 1.

The heated water at the outlet from the heat exchanger 1 through the respective outlet fitting 6b can be sent to one of the boilers 105, 106 according to the needs, so as to feed them with already preheated water and thus reducing the energy overall required to maintain the operating temperatures of the relative machine 100.

Similarly, also the hot waste water accumulated in the housing compartment 302 of the discharge container 300 can be sent to one of the boilers 105, 106 or discharged through the final discharge 101 of the machine 100 for coffee dispensing.

The heat exchanger 1, the discharge container 300 provided with said heat exchanger 1, as well as the machine 100 for coffee dispensing provided with such discharge container 300 and the relative heat exchanger 1 described above solve the problems encountered in the prior art and achieve important advantages.

First of all, the preheating actuated by the heat exchanger on the supply water coming from the water network or from a similar source allows a significant reduction of the overall heat losses of the machines, as it permits exploiting the heat of the excess water from the coffee extractions.

Naturally, the preheating of the supply water allows an increase in the performance of the machines which must use less time and energy to reach operating temperatures.

It should also be considered that the powers of the internal components of the machines on which the heat exchangers are installed according to the present invention are thus optimized.

Finally, it should be highlighted that the preheating of the water supplied by heat exchangers such as the one described above allows a significant reduction in the energy consumption of the machines for coffee dispensing.

1. A heat exchanger for discharge containers of solenoid valves of machines for coffee dispensing, the heat exchanger comprising a body which can be placed inside a discharge container of at least one solenoid valve of a machine for coffee dispensing, the body comprising:
a first portion externally presenting a collection cavity of a hot waste fluid coming from the solenoid valve of the machine for coffee dispensing, the collection cavity defining a first surface of the first portion, arranged to come into contact with the hot waste fluid of the solenoid valve and a second surface facing the opposite side from the first surface; and
a second portion presenting a primary surface in contact with the second surface of the first portion and a secondary surface opposed to the primary surface, the secondary surface of the second portion of the body being arranged to come into contact with a heat exchange fluid of the machine for coffee dispensing having a different temperature from the temperature of the hot waste fluid of the solenoid valve of the machine, the first and second portion of the body of the heat exchanger allowing an exchange of heat, by conduction, between the hot waste fluid of the solenoid valve in contact with the first surface of the first portion of the body and the heat exchange fluid of the machine for coffee dispensing in contact with the secondary surface of the second portion of the body of the heat exchanger.

2. The heat exchanger according to claim 1, wherein the second portion of the body of the heat exchanger comprises a transit duct of the heat exchange fluid of the machine for coffee dispensing, the transit duct presenting:
a supply fitting of the heat exchange fluid coming from the machine for coffee dispensing which develops outside the first portion of the body of the heat exchanger;
an outlet fitting of the heat exchange fluid directed towards the machine for coffee dispensing which develops outside the first portion of the body of the heat exchanger, preferably substantially parallel to the supply fitting; and
at least one transit segment developing inside the first portion of the body of the heat exchanger, preferably in correspondence of the first surface of the latter, the transit segment being in fluid communication with the supply fitting and the outlet fitting.

3. The heat exchanger according to claim 2, wherein:
the primary surface of the second portion of the body of the heat exchanger is defined by the outer surface of the transit duct of the heat exchange fluid at least in correspondence of the transit segment;
the secondary surface of the second portion of the body of the heat exchanger is defined by the internal surface of the transit duct of the heat exchange fluid at least in correspondence of the transit segment; and
the second surface of the first portion of the body of the heat exchanger is defined by the surface of the first portion in direct contact with the outer surface of the transit duct of the heat exchange fluid at least in correspondence of the transit segment.

4. The heat exchanger according to claim 2, wherein the transit segment of the transit duct defining the second portion of the body of the heat exchanger develops inside of the first portion of the body of the latter according to a substantially C-shaped path.

5. The heat exchanger according to claim 2, wherein the first portion of the body of the heat exchanger presents at least one auxiliary heat exchange area provided with a plurality of fins for heat exchange.

6. The heat exchanger according to claim 5, wherein the auxiliary exchange area is arranged on a third surface of the first portion of the body of the heat exchanger facing the opposite side with respect to the first surface and outwards, the second portion of the body of the heat exchanger and the second surface of the first portion of the same body being interposed between the first and the third surface of the first portion.

7. The heat exchanger according to claim 2, wherein the first portion of the body of the heat exchanger presents a substantially flattened external and/or overall conformation.

8. The heat exchanger according to claim 2, wherein the first portion of the body of the heat exchanger presents a substantially trapezoidal shape, preferably narrowing as it approaches the supply and outlet fittings of the transit duct.

9. The heat exchanger according to claim 2, wherein the supply fitting and the outlet fitting of the transit duct of the heat exchange fluid of the machine for coffee dispensing each develops transversely, preferably perpendicularly to a prevailing development plane of the first portion of the body of the heat exchanger.

10. The heat exchanger according to claim 1, wherein the first portion of the body of the heat exchanger presents an overall size of less than the dimensions of a housing compartment of the discharge container of the solenoid valve of the machine for coffee dispensing.

11. A discharge container for solenoid valves of machines for coffee dispensing, the discharge container comprising:
a structure defining at least one housing compartment for collecting a hot waste fluid coming from at least one solenoid valve of a machine for coffee dispensing;
at least one inlet connectable to a solenoid valve of a machine for coffee dispensing to allow the passage of the relative hot waste fluid towards the housing compartment of the structure;
at least one outlet to allow the outflow of the hot waste fluid accumulated inside the housing compartment of the discharge container; and
at least one heat exchanger according to claim 1.

12. The discharge container according to claim 11, wherein the heat exchanger has the collection cavity of the hot waste fluid coming from the respective solenoid valve of the machine for coffee dispensing and, consequently, the first surface of the first portion of the relative body arranged below the inlet of the hot waste fluid.

13. The discharge container according to claim 12, wherein the body of the heat exchanger is interposed between the inlet of the hot waste fluid of the solenoid valve of the machine for coffee dispensing and outflow outlet.

14. A machine for coffee dispensing of the type comprising:
at least one general supply valve connectable to a water network or a similar water supply source arranged in series with a feed pump;
at least one indirect heating boiler of the water and at least one direct heating boiler of the water operatively arranged between the general valve and at least one solenoid valve for dispensing the coffee;
a hydraulic circuit developing between the general supply valve, the boilers and the solenoid valve for dispensing coffee; and
at least one discharge container according to claim 11, in fluid communication with the solenoid valve through at least one exhaust duct of the hydraulic circuit.
